(19) United States
(12) Patent Application Publication
(10) Pub. No.: US 2012/0208171 A1
(43) Pub. Date: Aug. 16, 2012

(54) Device and Method for Studying Flashcards

(76) Inventor: Tammy L. Gordon, Elma, NY (US)

(21) Appl. No.: 13/354,086

(22) Filed: Jan. 19, 2012

Related U.S. Application Data
(60) Provisional application No. 61/434,123, filed on Jan. 19, 2011.

(51) Int. Cl. G09B 29/02

(52) U.S. Cl. 434/430

(57) ABSTRACT

A device for assisting a student in studying flashcards is presented, comprising a first pocket joined to a second pocket, each pocket having an open end with closures. The pockets are hingedly attached so that the pockets may be folded over onto each other. The first pocket has a “study” label, and the second pocket has a “learned” label, for indicating the flashcards to be contained within each. Also, a method is provided for using the device for studying flashcards where the student removes and reviews the flashcards from each pocket and determines their knowledge of each flashcard. The learned flashcards are placed into the second pocket and those that are not learned are placed into the first pocket. This is repeated until a predetermined condition is met.

### CROSS-REFERENCE TO RELATED APPLICATION

This application claims priority to U.S. Provisional Application Number 61/434,123, now pending, filed on Jan. 19, 2011, the disclosure of which is incorporated herein by reference.

### FIELD OF THE INVENTION

The invention relates to study aides, and more particularly to devices used to study flashcards.

### BACKGROUND OF THE INVENTION

Flashcards are well-known for assisting students of all ages in learning new material. Stacks of flashcards are prepared and reviewed by students, but no device is known for organizing and studying flashcards using a structured methodology. Accordingly, there is a need for a device for the structured studying of flashcards and a method for studying using the device.

### BRIEF SUMMARY OF THE INVENTION

The present invention may be embodied as a device for assisting a student in carrying, storing, organizing, and studying a set of flashcards comprising a first pocket and a second pocket. Each pocket having a first wall and a second wall joined together at their respective first sides, second sides, and second ends, leaving the first ends unattached to form an open end of each pocket. The first pocket is joined at its second side to the first side of the second pocket. The first pocket and second pocket are hingedly attached such that the pockets may be folded over onto each other. Each of the first and second pockets have closures at their respective open ends.

The first pocket has a “study” label—i.e., a label indicating that the flashcards to be contained in the first pocket are those which need further study. The second pocket has a “learned” label—i.e., a label indicating that the flashcards to be contained in the second pocket are those which are known by the student and need only review.

The present invention may also be embodied as a method for studying flashcards by a student, comprising the steps of providing a study device as described above and containing flashcards, removing the flashcards from the first pocket, and reviewing the flashcards to determine the student's level of knowledge. Flashcards that are learned are placed into the second pocket, and flashcards not yet learned are replaced into the first pocket.

The method further comprises removing the flashcards from the second pocket, and reviewing the flashcards to confirm the student's knowledge of the material. Any flashcards that have not been learned are placed into the first pocket, and the flashcards which have been confirmed as learned are replaced into the second pocket.

The steps of the method are repeated until a pre-determined condition is met. The condition may be a length of time, a level of mastery, or otherwise.

### DESCRIPTION OF THE DRAWINGS

For a fuller understanding of the nature and objects of the invention, reference should be made to the following detailed description taken in conjunction with the accompanying drawings, in which:

FIG. 1 depicts a device according to an embodiment of the present invention;

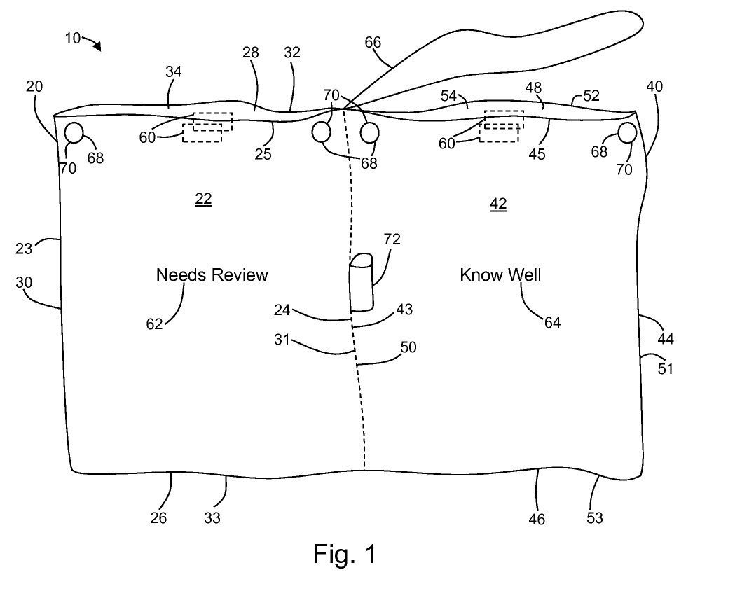

FIG. 2 is a diagram showing an exemplary technique for forming the inventive device from a single piece of material; and

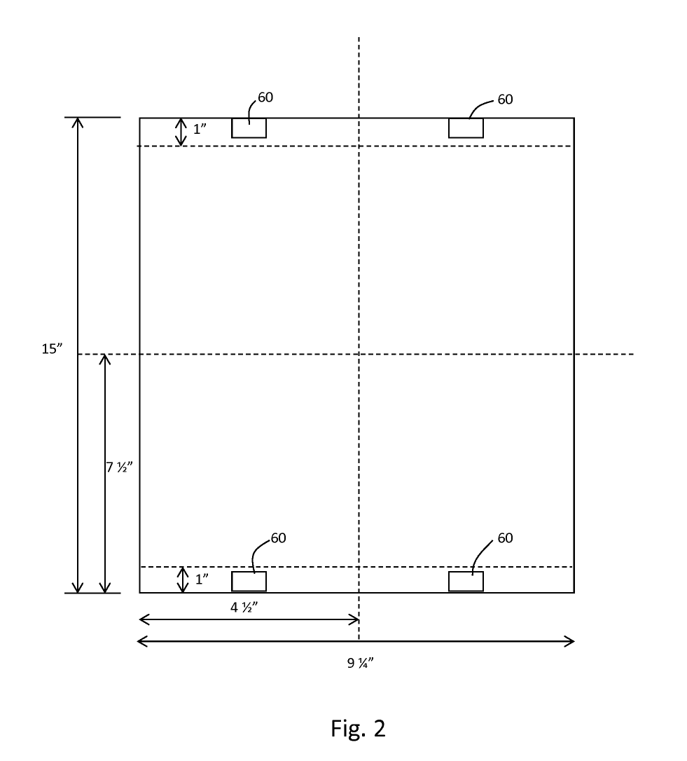

FIG. 3 is a chart depicting a method according to an embodiment of the present invention.

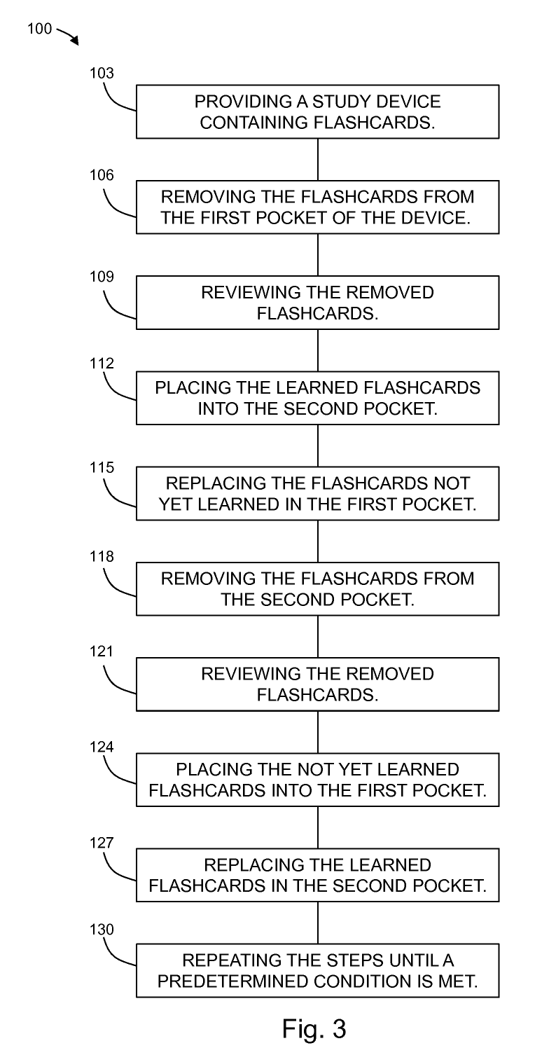

### DETAILED DESCRIPTION OF THE INVENTION

Flashcards are commonly known in the art as a set of cards having information recorded thereon, the information usually pertaining to a topic common to the cards of the set. Flashcards commonly measure three inches by five inches or five inches by seven inches, but may be any size. Flashcards are often made from heavy weight paper materials such as card stock. The information contained on each flashcard may be presented in the form of a question on a first side of the flashcard with the corresponding answer on a second side of the flashcard. Common “index cards” are often used as flashcards because blank index cards are readily available, and a student may prepare the blank index cards with the desired information.

The present invention may be embodied as a device 10 for assisting a student in carrying, storing, organizing, and studying a set of flashcards. The device 10 has a first pocket 20 and a second pocket 40 (reference is made to the components of the first pocket 20, but it should be recognized that the second pocket 40 is similarly configured).

The first pocket 20 has a first wall 22, which is generally rectilinear, having a first side 23, a second side 24, a first end 25, and a second end 26. The first pocket 20 further comprises a second wall 28 proximate to, and substantially parallel with, the first wall 22. The second wall 28 is generally configured similar to the first wall 22, with a first side 30, a second side 31, a first end 32, and a second end 33. The second wall 28 may be the same size and shape as the corresponding first wall 22, or the second wall 28 may be bigger, smaller, and/or differently shaped than the first wall 22. The first wall 22 and the second wall 28 are joined to one another at each of the first sides 23, 30, second sides 24, 31, and second ends 26, 33, thereby forming the first pocket 20 configured with a first open end 34 at the first ends 25, 32.

As previously stated, the device 10 further comprises a second pocket 40 which may be generally configured similar to the first pocket 20—having a first wall 42 and a second wall 48 joined together at their respective first sides 43, 50, second sides 44, 51, and second ends 46, 53, to form the second pocket 40 with a second open end 54 at the first ends 45, 52.

The first pocket 20 is joined to the second pocket 40 along the second side 24, 31 of the first pocket 20 and the first sides 43, 50 of the second pocket 40. As such, the pockets are positioned adjacent to one another with the first open end 34 and the second open end 54 along the same side of the joined form. The first pocket 20 and second pocket 40 are hingedly attached such that the pockets 20, 40 may be folded over onto each other.

Each of the first and second pockets 20, 40 have one or more closures 60 at the first ends 25, 32, 45, 52. The closures 60 may be centered or otherwise located along the first ends 25, 32, 45, 52. In this manner, the first open end 34 and the second open end 54 may be selectively closed by the student. The closures 60 may be of any type, including, without limitation, magnets, snap fasteners, hook-and-loop, and the like. The closures 60 may be configured such that when the device 10 is folded, the closures 60 cause the first pocket 20 to attach to the second pocket 40, thereby maintaining the device 10 as folded for enhanced portability. In embodiments where the closures 60 are magnets, the magnets of the first pocket 20 may be configured to attract the magnets of the second pocket 40 (e.g., north pole-to-south pole). In this way, the same magnets may be used to close the open ends 34, 54 and also to maintain the device 10 in the folded configuration. When other types of closures 60 are used, the closures 60 may further comprise additional component to keep the device 10 folded.

The device 10 may be made from any suitable material, including, without limitation textiles, plastics, elastomers, composites, and combinations of these. Where a textile it used, it may be, for example, a woven or a non-woven fabric. Each component of the device 10 (e.g., the pockets 20, 40 and walls 22, 28, 42, 48) may be formed from a separate piece of material. In other embodiments, it has been found convenient to form the main components of the device 10 from a single piece of material (further described below). The material can be colored, patterned, embossed, or otherwise fashioned to be attractive. For example, the material may have a camouflage, plaid, flowered, or other pattern.

The first pocket 20 and the second pocket 40 each have a label indicating the status of the flashcards to be contained within the respective pocket 20, 40. The first pocket 20 has a “study” label 62—i.e., a label indicating that the flashcards to be contained in the first pocket 20 are those needing further study. Suitable study labels 62 include, without limitation, any of the words “work,” “review,” or “more”; the phases “more review,” “needs more review,” “needs practice,” or “needs more practice”; or an icon, such as a question mark, an ‘X’, a red light, etc. The study label 62 may include more than one formative. The second pocket 40 has a “learned” label 64—i.e., a label indicating that the flashcards to be contained in the second pocket 40 are those that are known by the student and need only review. Suitable learned labels 64 include, without limitation, any of the words “good,” “okay,” “ok,” “known,” “learned,” or “mastered”; the phrase “knows well”; or an icon, such as a check mark, a smiley face, a thumbs up, a star, a green light, etc. The learned label 64 may include more than one formative.

The device 10 may further comprise a strap 66, such as a wrist strap, shoulder strap, etc. The device 10 may comprise one or more holes 68 for fixation in, or to, other objects. For example, a device 10 may comprise two holes 68 configured to be clipped into two rings of a common three-ring binder. The holes 68 may further comprise grommets 70 for reinforcement.

The device 10 may further comprise a utensil mount 72 between the first and second pockets 20, 40. For example, the utensil mount 72 may be a narrow pocket suitable for holding a writing utensil, such as a pen, pencil, etc. In another embodiment, the utensil mount 72 may be an elastic loop or hook-an-loop fastener for attaching a writing utensil.

As mentioned above, the device 10 may be advantageously manufactured from a single piece of material. This method of manufacturing is described by way of the following example wherein the device is configured for use with three inch by five inch flashcards, which is intended to be non-limiting. The size of the raw material is approximately 9 ¼″ by 15″, although, the size may vary depending on use/style. The 9 ¼″ width generally has side seams that are no more than ½″ and serged for stability.

The 15″ height is folded in half to 7 ½″ on either side and creased with an iron (fabric should be folded inside out), and the top 1″ seams are folded and creased with an iron on both edges. The 9 ¼″ width is folded and creased with an iron on both sides so that each side is approximately 4 ½″ wide (“pocket portions”). The crease between the 4 ½″ pocket portions will be later sewn to create two pockets. A magnet may be centered in each 4 ½″ seam making sure that the north pole of the magnet is directed towards the inside of the pocket on one wall, and the south pole is directed towards the inside of the pocket on the opposing wall.

Fabric glue (for example, FabricTac™, etc.), which is flexible, fast drying, and permanent, is used to glue around three sides of the magnet to allow flexibility as well as assuring that the magnet does not move. Each magnet seam is securely sewn along the 9″ width close to the magnets. If a magnetic closure is not being used, after the top seam is sewn, the closure (e.g., button, zipper, snap, Velcro, hook/eye catch, etc.) is attached at the top (first end) of each 4 ½″ pocket portions.

The pocket is now turned inside right so that the fabric design is showing on the outside. The pocket may be ironed again if necessary to make the seams flat and the corners square. Then, the pocket is sewn down the middle crease to form the two 4 ½″ pockets with magnetic closures. All threads are trimmed so that the final product is finished ready for use.

A label is sewn, ironed-on, or otherwise affixed to each pocket portion to indicate “study” or “learned” content. The labels may be affixed to a location on each pocket portion, for example, centered at the top of each of them. The labels may be located on the pocket portions on the same side of each pocket portion such that the labels are both visible at the same time when the device is unfolded.

The present invention may also be embodied as a method 100 for studying flashcards by a student. The method 100 comprises the steps of providing 103 a study device as described above. The device is provided with flashcards, which may be in any configuration for a particular study session. For example, the flashcards may all be contained in the first pocket—having the “study” label—if this study session is the first time these flashcards will be used by this student. In another study session, a portion of the flashcards—those that have already been learned—may be contained in the second pocket, while the remainder of the flashcards are in the first pocket.

The student removes 106 the flashcards from the first pocket of the device. The flashcards are reviewed 109 to determine the student's level of knowledge. This is done in known ways. For example, the student may review the question on the first side of each card. The student will attempt to answer the question without looking at the answer on the second side of the card. Then, the student reviews the answer on the second side to determine whether their attempted answer was correct. In another example, the review may be conducted with the help of another person who orally quizzes the student using the questions and answers on the flashcards.

The flashcards that have been answered correctly are placed 112 into the second pocket, and the flashcards that have not yet been learned are replaced 115 into the first pocket.

The student removes 118 the flashcards from the second pocket. The flashcards are individually reviewed 121 to confirm the student's knowledge of the material. This review happens in a similar way as that described above. Any flashcards that have not been learned (i.e., not correctly answered) are placed 124 into the first pocket. The flashcards that have been learned (i.e., correctly answered) are replaced 127 into the second pocket.

The steps of the method are repeated 130 until a particular pre-determined end condition is met. For example, the condition may be a length of time, in a non-limiting example, the student may study in this way for 5-15 minutes. In another embodiment, the steps are repeated 130 until the student has learned all the flashcards—in other words, all the flashcards are in the second pocket. In another embodiment, the steps are repeated until each flashcard has been correctly answered at least five times.

The steps of the method 100 may be performed in various orders. In an embodiment, it has been found advantageous to first review any flashcards in the second pocket to confirm the status of these flashcards before moving on to review the flashcards in the first pocket.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A device for assisting a student in studying flashcards, comprising:
a first pocket and a second pocket, each pocket being configured to contain a plurality of flashcards, and each pocket comprising:
a first wall having a first side, a second side, a first end, and a second end, and a closure at the first end;
a second wall having a first side, a second side, a first end, and a second end, and a closure at the first end; and
wherein the second wall is adjacent to the first wall and the first and second walls are attached at the respective first sides, second sides, and second ends, and the closure of the first side is removably attached to the closure of the second side;
wherein the second side of the first pocket is hingedly attached to the first side of the second pocket, and at least one of the closures of the first pocket is configured to removably attached to at least one of the closures of the second pocket such that the device is selectively maintained in a folded configuration; and
wherein the first pocket has a study label and the second pocket has a learned label.

2. The device of claim 1, wherein the device is manufactured from a textile.

3. The device of claim 2, wherein the first and second side walls of the first and second pockets are formed from a single piece of textile, wherein the second ends of the first and second pocket are formed as a fold in the single piece of textile.

4. The device of claim 3, wherein the second side of the first pocket and the first side of the second pocket are formed by stitching the folded single piece of textile.

5. The device of claim 1, further comprising a utensil mount between the first and second pockets.

6. The device of claim 5, wherein the utensil mount is an elastic loop sized secure a writing utensil.

7. The device of claim 1, wherein the pockets are configured to contain flashcards having dimensions of 3 inches by 5 inches.

8. The device of claim 1, wherein the pockets are configured to contain flashcards having dimensions of 5 inches by 7 inches.

9. The device of claim 1, wherein each closure is a magnet configured to attract the other magnetic closures.

10. The device of claim 1, wherein the closures are snap fasteners configured to be removably attach to the other closures.

11. The device of claim 1, further comprising a strap.

12. The device of claim 1, further comprising one or more holes configured to cooperate with a corresponding number of clips of a binder.

13. The device of claim 1, wherein the learned label is selected from the group consisting of the words “good,” “okay,” “ok,” “known,” “learned,” and “mastered”; the phrase “knows well”; and an icon.

14. The device of claim 1, wherein the study label is selected from the group consisting of the words “work,” “review,” and “more”; the phases “more review,” “needs more review,” “needs practice,” and “needs more practice”; and an icon.

15. A method of studying flashcards to increase the knowledge of a student, comprising the steps of:
providing a study device of claim 1 and containing the flashcards in the first pocket and/or second pockets;
removing the flashcards from the first pocket;
reviewing each flashcard of the first pocket to determine the knowledge of the student;
placing each flashcard which is learned by the student into the second pocket;
replacing the remaining flashcards which are not learned into the first pocket;
reviewing each flashcard of the second pocket to confirm the knowledge of the student;
placing each flashcard which is not learned into the first pocket;
replacing the flashcards which are learned into the second pocket; and
repeating the steps until a pre-determined condition is met.

16. The method of claim 15, wherein the condition is a length of time.

17. The method of claim 15, wherein the condition is a level of mastery.

18. The method of claim 17, wherein a level of mastery is reached when each card has been correctly answered at least five times.
